(19) United States
(12) Patent Application Publication
(10) Pub. No.: US 2011/0004504 A1
(43) Pub. Date: Jan. 6, 2011

(54) SYSTEMS AND METHODS FOR SCORING A PLURALITY OF WEB PAGES ACCORDING TO BRAND REPUTATION

(76) Inventors: Edward Ives, Exeter, RI (US); David J. Smith, Viera, FL (US)

Correspondence Address: WOLF GREENFIELD & SACKS, P.C., 600 ATLANTIC AVENUE, BOSTON, MA, 02210-2206, US

(21) Appl. No.: 12/496,283

(22) Filed: Jul. 1, 2009

(51) Int. Cl. G06Q 10/00; G06F 17/30; G06F 3/14; G06Q 30/00

(52) U.S. Cl. 705/10; 715/205; 707/759; 707/769; 707/778; 707/912; 707/955; 707/957

(57) ABSTRACT

Systems and methods taught herein provide an objective scoring mechanism based at least in part on a brand reputation of an organization owning a web page. In one aspect, brand reputation information is used to assign a score to a web page indicating the page's trustworthiness. Thus, rather than determining trustworthiness only from the intrinsic content of the web page, or from extrinsic relationships between web pages, a user may be provided with an indication of trustworthiness from at least one brand reputation metric of the organization that makes the web page available.

### FIELD OF THE INVENTION

This invention relates generally to systems and methods for analyzing web pages. More particularly, it relates to systems and methods for evaluating web pages based at least in part on the brand reputation of the web page's owner/operator.

### BACKGROUND

The search engine field has fundamental challenges in the areas of enabling and establishing trust between users and content providers. Popular approaches have focused on programmatically utilizing information found within web page content, which can be leveraged as a proxy for indicating reputation. According to one conventional approach, web pages are scored based on the number of links from other web pages; pages with more links are considered to be more relevant and/or trustworthy and are ranked higher. This and other well-known approaches include examining recency of information, examining meta-tags, document types, and various other content analysis techniques.

Since web pages can be computer-generated, or easily copied from other sources, approaches that focus on analyzing web pages themselves are fundamentally unreliable, and various methods of gaming the analysis algorithms have been developed as a result. Some companies for instance build “link farms” which consist of multiple pages located at multiple domain names, which link to each other, in order to score more highly in search engine results. A fundamental conflict has arisen due to financial incentives that accrue to website owners whose web pages rank highly on search engines, versus consumers desire to find relevant and trustworthy information.

### SUMMARY OF THE INVENTION

What these approaches do not comprehend is that trust is a concept that fundamentally exists in consumer's minds, which cannot be elicited by simply programmatically examining web page content. David A. Aaker, in “Managing Brand Equity: Capitalizing on the Value of a Brand Name,” defines a brand as “a distinguishing name and/or symbol (such as a logo, trademark, or package design) intended to identify the goods or services of either one seller or a group of sellers, and to differentiate those goods or services from those of competitors.”

Thus, there is a need to be able to search the Internet via a search engine and have search results returned that are ranked in relation to the trust (in the brands associated with the search results) which consumers already hold in their minds.

According to some conventional approaches, search results are ranked at least in part on the output of systems that rate businesses utilizing on-line and off-line surveys of users of a search engine. These approaches focus on surveying search engine users on customer satisfaction, professionalism, cost, and ease of use, and then ranks results based on “business satisfaction ratings”. By limiting the surveys to users of the search engine, these approaches would likely entail significant bias due to self-selection. Additionally, business satisfaction ratings do not necessarily correlate with trust that exists in the minds of large numbers of consumers (for instance, a local, sole proprietor-owned hardware store may garner high business satisfaction ratings from its local customer base, but may have poor brand recognition throughout the rest of the United States).

Also, these conventional approaches relate to ranking “merchant businesses” only, according to business satisfaction data, and do not comprehend that users of search engines seek information not only from businesses but from government institutions, educational institutions, trade associations, and individuals.

Ries and Trout in their classic book “Positioning: Battle for the Mind”, for instance, point out repeatedly that a brand occupies a position in the mind. This important realization has led to the development of various approaches to measure the reputation of a brand. Determining consumers level of trust of in a brand requires either direct objective measurement of consumers attitudes towards the brand, utilizing well established research methodologies, or by representing consumer sentiment though one or more of a number of brand performance proxies that indicate the market success of the brand.

Brand reputation metrics may, for example, be based on various public domain and proprietary evaluation methodologies resulting in number-form metrics (referred to herein for convenience as “brand measurement metrics”) such as brand recognition metrics, brand equity metrics, brand familiarity metrics, brand preference metrics, brand awareness metrics, perceived brand quality metrics, brand association metrics, brand strength metrics, brand image metrics, brand ranking metrics, brand loyalty metrics, and brand trust metrics. Brand measurement metrics based on various surveys and proprietary evaluation methodologies are routinely published by firms such as Interbrand, Advertising Age, Gfk Roper, BrandWeek, and Harris Interactive.

Brand reputation metrics can also be based on various proxies (referred to herein for convenience as “brand performance proxies”) such as financial metrics (for instance, company revenues, unit sales, or market share), organizational size metrics (for instance, number of employees), marketing media spending metrics (for instance, advertising spending, internet advertising budget, etc.), a count of references to a brand in documents (e.g., web pages, news articles, journal articles, etc.), etc., or some combination thereof. Brand performance proxies could also include brand age metrics that measure the age of the organization (e.g., age of trademarks owned by the organization, age of a domain name owned by the organization, etc.). Another brand performance proxy could be website traffic (e.g., monthly or yearly traffic to a website, website traffic rank, direct navigation web traffic, etc.). In this respect, direct navigation web traffic is a measurement of the amount of web traffic that a web site has received over a given period of time resulting from users typing the domain's address directly into their browser address bar rather than locating it through a search engine. This particular metric, potentially easily captured, is a measurement of the consumer's ability to recall a particular brand (the domain name itself) and propensity to visit that brand's web site.

Various aspects of the systems and methods for taught herein score Internet URLs that identify web pages. One aspect provides an objective scoring based on the brand reputation of the organization owning the web page. Another aspect is to provide a URL scoring method that is scalable and can be applied to extremely large sets of web pages. Additional aspects will become apparent in view of the following description and associated figures.

One aspect of the present teaching is directed to taking advantage of the existence of brand reputation information to assign a score to each URL, where the score is a measure of the trustworthiness of the web page. Rather than determining trustworthiness only from the intrinsic content of the web page, or from extrinsic relationships between web pages, a method consistent with the teaching determines trustworthiness from at least one brand reputation metric of the organization owning the web page. Intuitively, a web page should be trustworthy (regardless of its content) if it has been generated by a respected or widely recognized organization or person. The score based on the brand reputation metric can then be utilized to either rank the web page (as represented by the URL), or as an input to a larger web page ranking system. The owner (domain name owning organization) of a web page's web site can be easily determined through widely available WHOIS information over the internet, through a database lookup, entry by an editor into a GUI created for this purpose, or other similar methods.

Because brand reputation metrics can be used to rapidly evaluate trustworthiness, the most trustworthy web pages correspond to those web pages to which the highest brand reputation metric is given. Thus, a high score indicates that a web page is considered trustworthy. Most likely, these are pages to which someone performing a search would like to direct his or her attention. Because higher brand reputation metric values correspond to greater levels of trust, this method of scoring pages assigns higher scores to pages with higher brand reputation metric values.

One advantage of aspects of the illustrative system is that it is able to determine automatically an objective indicia of trustworthiness of a web page. Thus, a user can evaluate trustworthiness of the web page in relation to other web pages simply from its rank in the search results.

In one aspect, an example computer-implemented (e.g., automated or semi-automated) process is provided for scoring web pages. The process includes identifying a plurality of domain name owning organizations; assigning organization scores to each of the domain name owning organizations based at least in part on brand reputation metrics; identifying a plurality of web pages, at least some of the web pages having URLs containing at least one domain name owned by one or more of the domain owning organizations; assigning scores to each of the web pages based on organization scores associated with the one or more domain name owning organizations and processing the web pages according to the assigned scores.

In accordance with yet another implementation, a method for scoring web pages includes determining the domain of a web page; determining the brand reputation of the domain itself; and calculating a score for the web page based on the brand reputation.

In accordance with yet another implementation, a method for scoring web pages includes determining the domain of a web page; determining the amount of direct navigation web traffic that domain has received over a given period of time from users typing the domain's address directly into their browser address bar rather than locating it through a search engine; and calculating a score for the web page based on the direct navigation web traffic.

In some cases there may be multiple brands owned by the organization. In Disney Corporation's case for instance, the “Mickey Mouse” brand may garner a higher reputation in brand surveys than the “Disney” brand. Various embodiments consistent with these teachings could utilize either a brand reputation metric of the brand name representing the organization itself, the maximum or average of a brand reputation metric of its owned brand names, a specific brand name representative of the website, a specific brand name representative of the web pages being scored, or some combination thereof.

In accordance with yet another example implementation, a method for scoring web pages includes ranking websites and web pages based on direct navigation web traffic counts. This method could have some advantages over other methods in that it is resistant in some ways to schemes to influence the ranking; relying on addresses typed directly by users, often from memory, obviates the utility of “link farms” (large collections of sites and web pages with links designed to boost the search engine score of particular links). One can of course imagine other problematic scenarios such as automated computer programs creating web traffic and appearing to be end-users, people in third-world countries being paid to visit web sites in order to boost traffic rankings, etc. This method could however provide improved “resistance” to rank influencing efforts if combined with other approaches.

Utilizing metrics such as brand measurement metrics or brand reputation proxies provides the benefit of leveraging existing metrics which have extensive research behind them, as well as many years of utilization and improvement. In the case of proxies, some of the proxies themselves actually are a brand with a strong reputation (by way of example, The “Fortune 1000” rankings, The “Forbes 500” rankings, The “Consumer Reports Passenger Van” Rankings). In these cases, the brand measurement metric or brand reputation proxy chosen may itself provide significant value by having a particular limiting focus or reputation itself in a particular area of expertise.

Some embodiments may utilize multiple brand measurement metrics, brand reputation proxies, or combinations thereof to provide more targeted search results based on the individual search being performed. For instance, on a site where users perform searches primarily related to passenger vans, or on a general search site where a particular search can be determined to be related to passenger vans based on analysis of the search keywords or other information, scoring the search results according to the “Consumer Reports Passenger Van” Ranking (which is based on a rigorous surveying methodology involving the solicitation of input from a wide variety of passenger van consumers on a broad spectrum of attributes), would likely provide highly targeted, relevant, and trustworthy results. If a user then performs a second search where it can be determined that the topic of the search is related to mutual funds, scoring the search results according to the “Morningstar Mutual Fund” Ranking would likely provide highly targeted, relevant and trustworthy results. In this fashion, individual searches could be matched against different scoring methodologies for maximum relevance and trust.

Some embodiments may utilize brand reputation metrics broken out on a geolocation basis. For instance, brand awareness for “Ben & Jerry's” Ice Cream may be particularly high in the United States, but low in Madagascar; similarly, “Del's Lemonade” may have high brand awareness in Rhode Island, but low brand awareness everywhere else. Brand reputation metrics could be broken out and tracked on a geolocation basis, for instance country, region, zip code, metropolitan statistical area, town, city, or some other geolocation basis. For search applications this information could be used to tailor search results to a particular locality based on brand reputation relative to that locality.

### BRIEF DESCRIPTION OF THE DRAWINGS

FIG. 1 is a block diagram illustrating the relationships between a Web Page, a Web Site, a Domain Name, a Domain Name Owning Organization, and a Brand Name of the Domain Name Owning Organization;

FIG. 2 is a block diagram depicting an example system for scoring a plurality of web pages according to brand reputation, in accordance with some embodiments of the invention;

FIG. 3 is a flowchart depicting an example process for scoring a web page based on its domain name owning organization's Brand Reputation Score, in accordance with some embodiments of the invention;

FIG. 4 is a representation of an example GUI for receiving user search terms and presenting references and hyperlinks to web pages to the user, in accordance with some embodiments of the invention;

FIG. 5 is a collection of database table content, in accordance with some embodiments of the invention;

FIG. 6 is a representation of an example schema which may be employed to store information relating to content and brand reputation scores, in accordance with some embodiments of the invention;

FIG. 7 is a block diagram depicting an example computer system on which some embodiments of the invention may be implemented; and

FIG. 8 is a block diagram depicting an example memory on which instructions embodying some aspects of the present invention may be stored.

### DETAILED DESCRIPTION

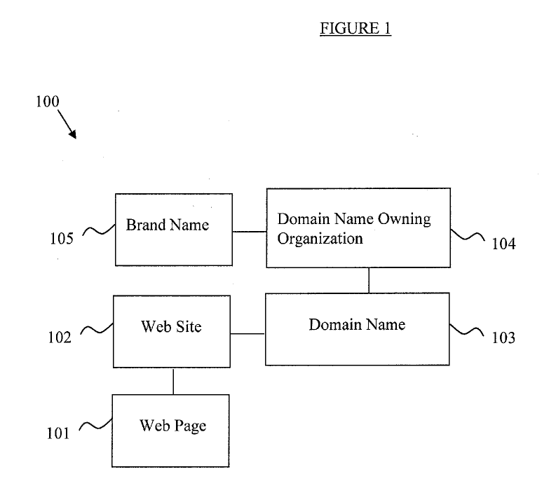

FIG. 1 is a block diagram illustrating example relationships between a Web Page 101, a Web Site 102, a Domain name 103, a Domain Name Owning Organization 104, and a Brand Name 105 of the Domain Name Owning Organization. While only one of each entity is shown in FIG. 1, in practice any number of each entity may exist, with the limitations that a Brand Name can only be owned by one Brand Name Owning Organization, a Domain Name can only be owned by one Domain Name Owning Organization, and a Web Page can only exist on one Web Site.

The Web Page 101 is hosted on the Web Site 102. Web Site 102 utilizes the Domain Name 103 in its Universal Resource Locators (URLs) and in its DNS entries. Domain Name 103 is registered to Domain Name Organization 104. Domain Name Owning Organization 104 owns Brand Name 105.

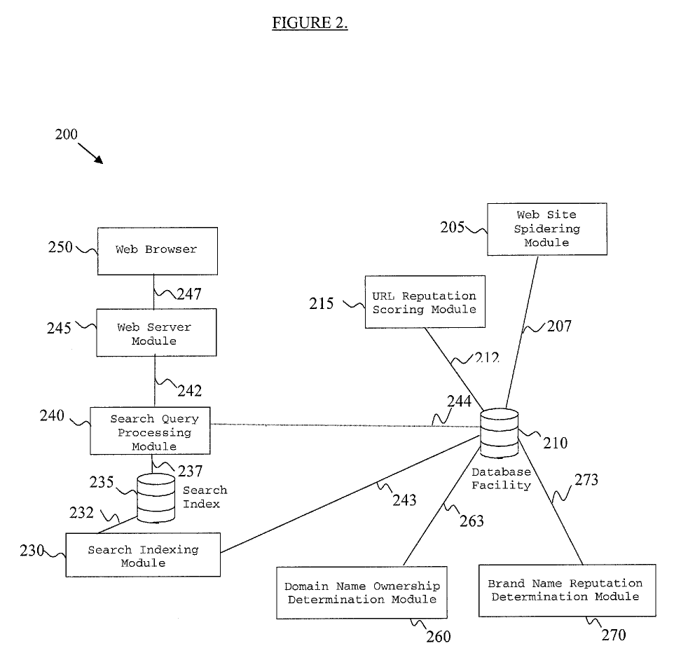

FIG. 2 depicts an example system 200 for locating, indexing, and providing access web pages. Specifically, system 200 includes components which locate, assess, and index web pages, and make that content available to a user (e.g., via the Internet). A user of system 200 may navigate or search for specific content.

System 200 includes web site spidering module 205, which in some embodiments may comprise one or more software components configured for execution on a computer (not shown) connected to the Internet or other public or private network. Specifically, web site spidering module 205 may be programmed to retrieve systematically a collection of URLs, such as from one or more web sites indicated (e.g., by a human or software-based editor) as including web pages, or any other publicly available or private collection of content. If configured to examine publicly available web sites, web site spidering module 205 may include features commonly available on spidering software, such as features which instruct web site spidering module 205 to examine only certain page levels of the web site(s), to filter URLs based on text strings found therein and/or in the title of corresponding pages, and/or to filter URLs based on text found in the content of associated pages. Web site spidering module 205 may include features to limit content to only certain types of content, such as by content type (by way of example, instructional “How-To” content, images, product listings, information on companies or individuals), by content provider type (by way of example, government agencies, educational institutions, trade associations, Fortune 1000 corporations, or individuals). Web site spidering module 205 may include a feature to extract the domain name from the URLs by removing leading information (by way of example, for “http://www.apple.com”, the leading “http://www.” could be stripped, for instance, with the remainder being “apple.com”) and store it in a separate field. Some embodiments may place this domain name extraction capability in domain name ownership determination module 260 referenced below, or in other modules.

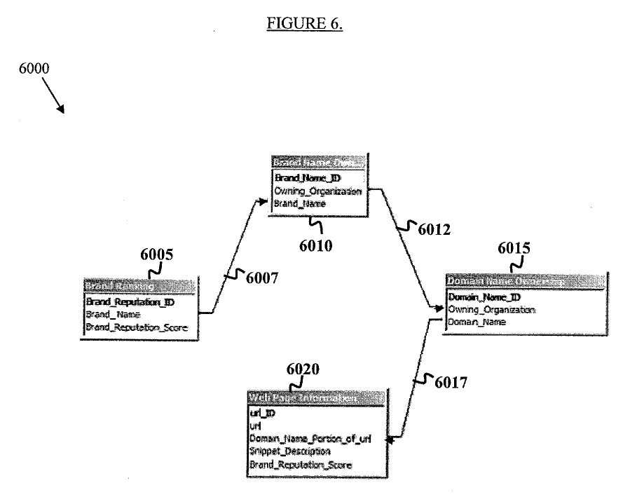

In the example system 200 shown, the URLs located by web site spidering module 205 are loaded to database facility 210. Web site spidering module 205 communicates with database facility 210 via link 207, which, like every other link shown in FIG. 2, may comprise any one or more communications networks, such as a LAN, WAN, wireless network, the Internet, other network, or a combination thereof. Database facility 210 may, in some embodiments, comprise any suitable database management system application and any suitable amount and type of storage media, as the invention is not limited to any particular implementation. Database facility 210 may store, in any suitable fashion (e.g., in a relational or other database structure), information relating to web pages, such as URLs located by web site spidering module 205, snippets, domain names, and information required for operation of system 200. An example schema which may be implemented by database facility 210 to store information is described below with reference to FIG. 6.

System 200 includes domain name ownership determination module 260, which in some embodiments may comprise one or more software components configured for execution on a computer (not shown in FIG. 2) connected to the Internet or other public or private network. Specifically, domain name ownership determination module 260 may be programmed to systematically retrieve domain names stored in database facility 210, then retrieve systematically the names of the owners of domain names contained in URLs stored in database facility 210, such as by querying an external database which references domain names to owning organization names, querying a WHOIS database, or by providing a GUI to enable an editor to provide input defining the owning organization for a given domain name.

In the example system 200 shown, domain name ownership determination module 260 communicates with database facility 210 via link 263, retrieves the domain name portion of a URL, determines the owning organization for the URL, and stores the owning organization in database facility 210 through a database function (such as, by way of example, a SQL INSERT or UPDATE command). An example schema which may be implemented by database facility 210 to store information is described below with reference to FIG. 6.

System 200 includes brand name reputation determination module 270, which in some embodiments may comprise one or more software components configured for execution on a computer (not shown) connected to the Internet or other public or private network. Specifically, brand name reputation determination module 270 may be programmed to retrieve systematically the reputation of brand names, such as by querying an external database which references organization names, brand names, and brand reputation metrics, or by providing a GUI to enable an editor to provide input defining reputation metrics for brand names, or a combination thereof.

A web page's reputation need not be based on brand measurement metrics, as embodiments of the invention can be implemented in numerous ways. For example, in some embodiments the web page's reputation may be based on various brand performance proxies. In other embodiments, the reputation may be based on a combination of various brand measurement metrics and brand performance proxies. In some embodiments, if a brand measurement metric or brand performance proxy is unavailable for a particular organization name or brand name, rules may be utilized to assign a predefined score. By way of example, unknown organizations owning “.edu” or “.gov” domain names may be assigned a predefined score based on a statistical average or other analysis of the scores of known organizations that own .edu and .gov brands, for instance. In some embodiments, if a score cannot be determined, or if a score is above or below a threshold, brand name reputation determination module 270 may assign a score or other indicia indicating that search results associated with the brand name should not be displayed by search query processing module 240, or indicating that web site spidering module 205 should not index web pages associated with the brand name.

In the example system 200 shown, brand name reputation determination module 270 communicates with database facility 210 via link 273, retrieves an owning organization, determines one or more brands owned by the owning organization, and determines an associated brand reputation score for the brands, and stores the brand reputation scores in database facility 210, by performing a database operation. A database operation may comprise one or more commands. For example, if the database utilized is a relational database, one or more SQL commands could be utilized for the database operation. If the database utilizes a non-relational database such as a Bigtable database, or a column-oriented database, a database-specific API command could be utilized for the database operation. An example schema which may be implemented by database facility 210 to store information in relational form is described below with reference to FIG. 6.

In the example system 200 shown, URL scoring module 215, in communication with database facility 210, is operable to access a URL, its owning organization, and the owning organization's brand reputation score stored in the database facility, and generates a URL score for the URL based at least in part on the brand reputation score and stores the URL score in database facility 210.

An example schema which may be implemented by database facility 210 to store information is described below with reference to FIG. 6. URL scoring module 215 communicates with database facility 210 via link 212, and in some embodiments, provides a graphical user interface (GUI) which accesses data stored in database facility 210 and enables an editor to assign brand reputation scores to web pages referenced by URLs. For example, a GUI presented by URL scoring module 215 may enable an editor to inspect URLs located by web site spidering module 205, inspect and assess a web page associated with each URL, inspect WHOIS information associated with the web site hosting the web page associated with the URL to determine the owning organization, research the reputation of the owning organization by examining one or more external lists of organizations and their brand reputation metrics, and assign a brand reputation score to the web page associated with each URL.

In another embodiment, URL scoring module 215 may automatically reference pre-stored brand reputation scores based on various brand measurement metrics including brand recognition, brand equity, brand familiarity, brand preference, brand awareness, perceived brand quality, brand associations, brand strength, brand image, brand loyalty, and brand trust, without the intervention of an editor.

In some embodiments, URL scoring module 215 may reference information determined by brand name reputation determination module 270 stored in database 210.

In some embodiments, the GUI presented by URL scoring module 215 may also enable an editor to provide input defining URLs to be stored in database facility 210. For example, the GUI may be configured to receive editor input via a keyboard, or may allow an editor to specify a file containing URLs for loading to database facility 210. Thus, it should be apparent that URLs stored in database facility 210 need not be located by web site spidering module 205, and may be located and/or loaded to database facility 210 using any suitable technique (including techniques which do not involve the use of URL scoring module 215), as the invention is not limited in this respect.

In some embodiments, URL scoring module 215 may comprise one or more software modules configured for execution on one or more computers (not shown in FIG. 2), although the invention is not limited to being implemented in this fashion. Any suitable combination of hardware and/or software may be used to implement URL scoring module 215.

Search indexing module 230 accesses database facility 210 via link 243 and constructs search index 235 via link 232, which may provide a reference to any one or more properties of web pages for use in later searching. For example, search index 235 may index web pages referenced by URLs in database facility 210 according to their content (e.g., text contained therein), so that subsequent searches for particular keywords contained within the web pages may be processed efficiently.

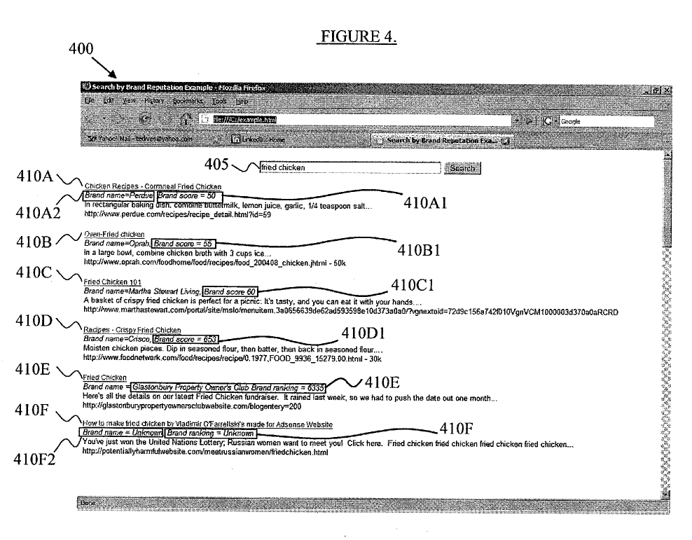

Search query processing module 240 provides search results to web server module 245 via link 242 in response to a search query, including URLs, Hyperlinks, Titles, Snippets (short descriptions or excerpts of web pages), and Brand Reputation Score by querying the search index 235 via link 237. One example web page results 400 generated by search query processing module 240 is described below with reference to FIG. 4. It should be appreciated, however, that any suitable manner of presenting web page results may be employed, and that the invention is not limited to the particular example embodiments disclosed herein. Further, it should be appreciated that search query processing module 240 may be implemented using any suitable combination of hardware and/or software components, as the invention is not limited to being implemented in any particular manner. For instance, search query processing module 240 could communicate directly with database facility 210 via optional link 244, instead of utilizing the search index 235.

Web browser 250 provides the user with access to results from search query processing module 240, and thus to URLs, Hyperlinks, Titles, snippets, and Brand Reputation Score. Web browser 250 may include any one or more browser programs, configured for operation on any suitable computing device (e.g., personal computer, personal digital assistant (PDA), cellular telephone, wireless device, any other device, or a combination thereof). In some embodiments, web browser 250 enables the user to navigate to and view web pages referenced by URLs in database facility 210 by issuing a retrieval request to web server module 245, which communicates with search index 235 via link 237. Web browser 250 may also enable the user to perform a search for web pages by communicating the parameters of a search request (e.g., one or more keywords) via link 247 to web server module 245, which then communicates the request via link 242 to search query processing module 240. Search query processing module 240 may then query search index 235 via link 237 in processing the search request, and utilize the results of the query in accessing web pages referenced by URLs in database facility 210 via link 244. The results of the search may then be communicated to web browser 250 via web server module 245.

It should be appreciated that example system 200 represents only one possible architecture of a system configured for locating and making available web pages, and that numerous variations on example system 200 are possible. For example, search query processing module 240 may instead communicate directly with database facility 210 (or some other component(s)) to perform search queries. Similarly, web server module 245 may communicate directly with database facility 210, which may generate web pages dynamically in response to user input. In addition, web browser 250 may provide access to functionality provided by URL scoring module 215 (e.g., via a web interface), such that URL scoring module 215 need not be a stand-alone component. Additionally, web site spidering module 205 may score web pages according to brand reputation as it retrieves URLs, or it may exclude certain URLs if a brand name cannot be determined, or if a score cannot be determined for a brand name, or if a score is below or above a threshold. Also, search query processing module 240 may exclude a result if a brand name cannot be determined, or if a score cannot be determined for a brand name, or if a score is below or above a threshold. Numerous variations on example system 200 may be envisioned, and Applicant intends these variations to be within the scope of the invention.

Some steps described above may be performed simultaneously or in different order. Also, the various steps described above may be performed by various machines and apparatuses; and not necessarily by those described or mentioned above. Other embodiments and uses of this invention will be apparent to those having ordinary skill in the art upon consideration of the specification and practice of the invention disclosed herein. The specification and examples given should be considered by way of example only, and it is contemplated that the appended claims will cover any other such embodiments or modifications as fall within the true scope of the invention.

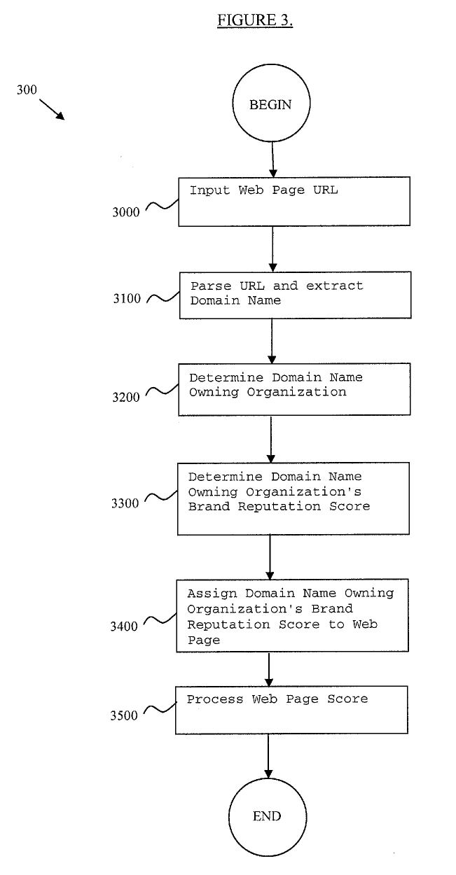

FIG. 3 depicts an example process 300 for locating, indexing, and providing access web pages. FIG. 3 shows one embodiment of a computer-implemented method for scoring a web page based on its domain name owning organization's brand reputation score. In a first act 3000 of the process the web page URL representing web page 101 is loaded either manually, read from database facility 210 where it has been previously stored by web site spidering module 205, or in any other manner. Next, in act 3100, the URL is parsed and the domain name 103 is extracted. The domain name owning organization 104 is then determined in act 3200, via lookup from database facility 210 where it has been previously stored by domain name ownership determination module 260, or in any other manner.

The domain name owning organization's brand reputation score is then determined in act 3300 via lookup from database facility 210 where the organization, brand name 105, and an associated brand measurement metric have been previously stored by brand name reputation determination module 270, or in any other manner. Next, in act 3400, a score is generated based at least in part on the brand reputation score of domain name owning organization 104, and is assigned to the URL representing web page 101 by web page reputation scoring module 215, or in any other manner. Finally, in act 3500, the score assigned to the URL is processed.

FIG. 4 depicts an example browser interface which a user may employ to supply search terms, and which may be employed to display the results of a search to the user. Browser interface 400 includes box 405, into which a user may supply input defining one or more search terms (in the example shown, “fried chicken”) for use in searching for a fried chicken recipe. Also shown on browser interface 400 are results of a search performed using the supplied search terms. Specifically, search results 410A-410F each provide a hyperlink to a web page which includes content matching the search terms supplied by the user. Also shown on browser interface 400 within the search results are brand names as in box 410A2. Also shown on browser interface 400 within the search results are rank-ordered brand reputation scores 410A1-410F1. In this example, lower brand reputation scores sort (i.e. are ranked) higher. It will be to appreciated that if a brand reputation score cannot be obtained for a particular brand, the brand reputation score may be populated manually, as discussed with reference to FIG. 2, or the brand reputation score may be assigned automatically by the use of pre-defined scoring rules. By example, shown on browser interface 400, box 410F2 indicates that a result 410F does not correspond to a known brand name. The brand ranking 410F1 associated with result 410F indicates that the brand reputation score is “Unknown” and result 410F has therefore sorted last, in accordance with a pre-defined scoring rule that unknown brand name results should be assigned higher scores so they will rank lower.

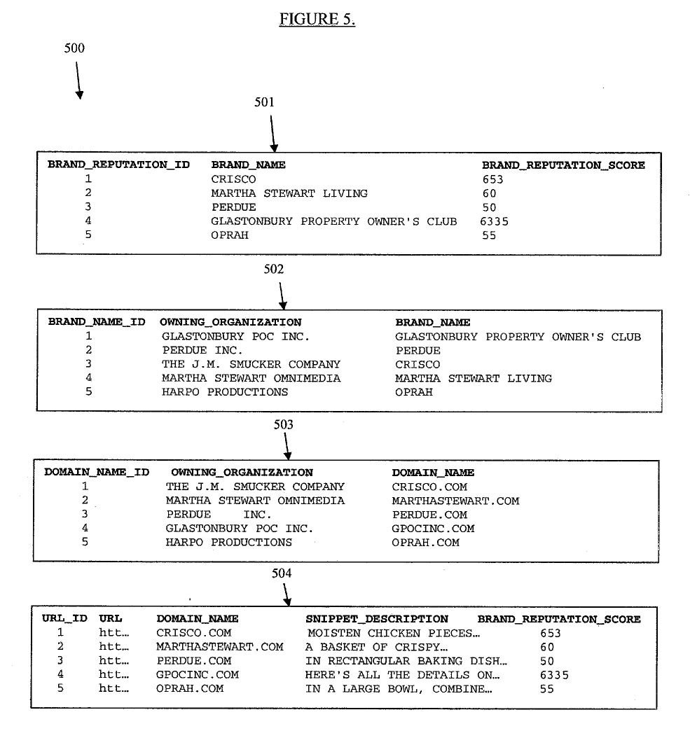

FIG. 5 depicts, by way of example, table content from database facility 210 in System 200. It will be observed that the data depicted in the tables matches the results depicted in FIG. 4, although some data in the depiction (for instance, the URL field) are displayed in truncated form due to diagram space limitations.

FIG. 6 depicts an example manner of storing web page, brand name, ownership, and reputation information (e.g., in database facility 210, FIG. 1). In particular, FIG. 6 depicts a schema for storing this information in relational format. Of course, it should also be appreciated that any of numerous non-relational data structures may alternatively be employed to store information relating to web pages, organizations, and their brand reputations, and that a data structure may include different tables and/or columns or fields than those shown in FIG. 6, or no tables at all if a relational database is not employed.

As those skilled in the art will readily appreciate, schema 6000 includes a plurality of tables, each containing a plurality of fields (e.g., columns) in which data elements relating to how-to information are stored. For example, in the exemplary schema 6000 shown, web page information table 6020 stores data elements relating to information retrieved by a spidering module (e.g., website spidering module 205, FIG. 2) in various fields, including a unique identifier, URL, the domain name portion of the URL, and a snippet of content from the web page. Web page information table 6020 also stores the brand reputation score assigned by URL scoring module 215 described below.

Domain name ownership table 6015 stores data elements relating to information retrieved by a domain name ownership determination module (e.g., domain name ownership determination module 260, FIG. 2) in various fields, including a unique identifier, an owning organization name, and a domain name.

As with most relational databases, certain fields in each table are related to fields in other tables via foreign keys to ensure that the information in each table remains consistent. As a result, foreign key 6017 is used to maintain consistency between the domain name portion of the URL field in web page information table 6020 and the domain name field in domain name ownership table 6015. The domain name ownership table 6015 also stores a unique identifier.

Brand name ownership table 6010 stores data elements relating to information retrieved by a brand name reputation determination module (e.g., brand name ownership determination module 270, FIG. 2) in various fields, including a unique identifier, an owning organization name, and a brand name.

Foreign key 6012 maintains consistency between owning organization names in in table 6015 and owning organization names in brand name ownership table 6010. This table maintains a cross-reference between owning organization names stored in domain name ownership table 6015 and brand names stored in brand ranking table 6005, described below.

Foreign key 6007 maintains consistency between this brand name in brand name ownership table 6010 and the brand name field in brand ranking table 6005. Brand ranking table 6005 stores data elements relating to information retrieved by a brand name reputation determination module (e.g., brand name reputation determination module 270, FIG. 2) in various fields, including a unique identifier, an brand name, and a brand reputation score (e.g., which may be used to sort search results for display, such as for display on interface 400, FIG. 4).

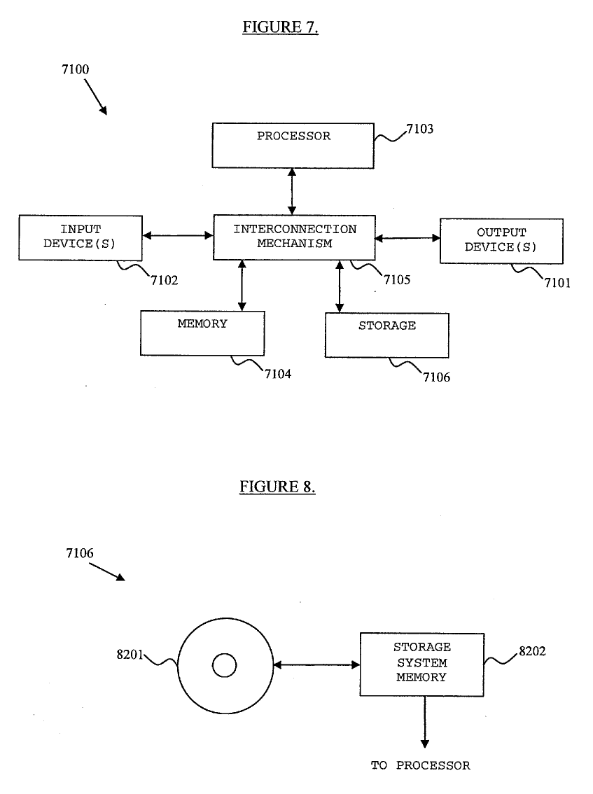

Various aspects of the systems and methods for practicing features of the invention may be implemented on one or more computer systems, such as the exemplary computer system 7100 shown in FIG. 7. Computer system 7100 includes input device(s) 7102, output device(s) 7101, processor 7103, memory system 7104 and storage 7106, all of which are coupled, directly or indirectly, via interconnection mechanism 7105, which may comprise one or more buses, switches, networks and/or any other suitable interconnection. The input device(s) 7102 receive(s) input from a user or machine (e.g., a human operator), and the output device(s) 7101 display(s) or transmit(s) information to a user or machine (e.g., a liquid crystal display). The processor 7103 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

The processor 7103 may also execute one or more computer programs to implement various functions. These computer programs may be written in any type of computer program language, including a procedural programming language, object-oriented programming language, macro language, or combination thereof. These computer programs may be stored in storage system 7106. Storage system 7106 may hold information on a volatile or non-volatile medium, and may be fixed or removable. Storage system 7106 is shown in greater detail in FIG. 8.

Storage system 7106 typically includes a computer-readable and writable nonvolatile recording medium 8201, on which signals are stored that define a computer program or information to be used by the program. A medium may, for example, be a disk or flash memory. Typically, in operation, the processor 7103 causes data to be read from the nonvolatile recording medium 8201 into a volatile memory 8202 (e.g., a random access memory, or RAM) that allows for faster access to the information by the processor 7103 than does the medium 8201. The memory 8202 may be located in the storage system 7106, as shown in FIG. 12, or in memory system 7104, as shown in FIG. 11. The processor 7103 generally manipulates the data within the integrated circuit memory 7104, 8202 and then copies the data to the medium 8201 after processing is completed. A variety of mechanisms are known for managing data movement between the medium 8201 and the integrated circuit memory element 7104, 8202, and the invention is not limited thereto. The invention is also not limited to a particular memory system 7104 or storage system 7106.

It should be appreciated that although system 200 provides a user with access to content by processing the user's search request, a user need not locate content by searching for it. For example, a web site implemented in accordance with embodiments of the invention may allow a user to browse or otherwise navigate various content categories, topics and entries, sorted by brand reputation, enabling the user to locate content without necessarily performing a search.

The elements described in this specification in plural form may also be construed as singular, unless specifically stated otherwise. The elements described in this specification in singular form may also be construed as plural, unless specifically stated otherwise.

Having thus described several aspects of at least some embodiments of this invention, it is to be appreciated that various alterations, modifications, and improvements will readily occur to those skilled in the art. Such alterations, modifications and improvements are intended to be part of this disclosure, and are intended to be within the spirit and scope of the invention. Accordingly, the forgoing description and drawings are by way of example only.

We claim:

1. A computer-implemented method of scoring a plurality of web pages, comprising computer-implemented acts of:
(A) querying an electronic database to identify an organization owning a domain name;
(B) using at least one external input, assigning a first score based at least in part on a brand reputation metric to the organization;
(C) identifying a URL which identifies a web page, the URL containing a reference to the domain name;
(D) assigning a second score to the web page based at least in part on the first score assigned to the organization; and
(E) processing the URL according to the second score.

2. The method of claim 1 wherein the brand reputation metric comprises a brand measurement metric.

3. The method of claim 2 wherein the brand measurement metric comprises a brand awareness metric.

4. The method of claim 1 wherein the brand reputation metric comprises a brand performance proxy.

5. The method of claim 4 wherein the brand performance proxy comprises a financial metric.

6. The method of claim 5 wherein the financial metric comprises a revenue metric.

7. The method of claim 4 wherein the brand performance proxy comprises a marketing media spending metric.

8. The method of claim 4 wherein the brand performance proxy comprises an organizational size metric.

9. The method of claim 8 wherein the organizational size metric comprises an employee count of the organization.

10. The method of claim 4 wherein the brand performance proxy comprises a count of references to the organization in documents.

11. The method of claim 10 wherein the documents comprise news stories.

12. The method of claim 4 wherein the brand performance proxy comprises a website traffic metric.

13. The method of claim 4 wherein the brand performance proxy comprises a brand age metric.

14. The method of claim 1 wherein processing includes storing in an electronic storage medium the second score in association with the URL.

15. The method of claim 14 wherein processing includes:
in response to a query from an end user,
selecting at least one URL which satisfies the query;
generating a list of hyperlinks corresponding to the at least one URL;
sorting the list of hyperlinks according to the assigned scores;
and displaying the sorted list of hyperlinks.

16. A computer implemented method of scoring a plurality of web pages, comprising computer-implemented acts of:
(A) identifying an organization;
(B) using at least one external input, assigning a first score to the organization based at least in part on a brand reputation metric;
(C) identifying a domain name owned by the organization;
(D) assigning a second score to the domain name based at least in part on the first score;
(E) identifying a URL that identifies a web page, the URL containing a reference to the domain name;
(F) assigning a third score to the URL based at least in part on the second score; and
(G) processing the URL according to the third score.

17. A computer readable medium having instructions recorded thereon, which, when executed by a computer, performs a method for scoring a plurality of web pages, the method comprising acts of:
(A) identifying an organization owning a domain name;
(B) using at least one external input, assigning a first score to the organization based at least in part on a brand reputation metric;
(C) identifying a URL which identifies a web page, the URL containing a reference to the domain name.
(D) assigning a second score to the web page based at least in part on the first score assigned to the organization; and
(D) processing the URL according to the second score.

18. A system for scoring a plurality of web pages, the system comprising at least one processor programmed to implement:
a location facility operable to receive a URL at which a web page is made available for access by an online provider;
a database facility, in communication with the location facility, operable to store the URL received by the location facility;
a web site spidering facility, in communication with the location facility, operable to identify at least one URL at which a web page is located and to communicate the at least one URL to the location facility;
a domain name ownership determination facility, in communication with the database facility, operable to access the domain name portion of a URL stored in the database facility and to store, in a data structure, an owning organization for the URL based on the ownership of the domain name;
a brand name reputation determination facility, in communication with the database facility, operable to access the owning organization stored in the database facility and to generate a brand reputation score for the owning organization and to store the brand reputation score in the database facility;
a URL scoring facility, in communication with the database facility, operable to access a URL, its owning organization, and the owning organization's brand reputation score stored in the database facility and generate a URL score for the URL based at least in part on the brand reputation score and to store the URL score in the database facility;
a search facility, in communication with the database facility, operable to access the URLs and URL scores stored in the database facility, and to create a search results page, the search results being sorted at least in part according to the URL scores.
